(19) United States
(12) Patent Application Publication
(10) Pub. No.: US 2012/0101614 A1
(43) Pub. Date: Apr. 26, 2012

(54) System and Method for Manufacturing Optical Network Components

(76) Inventors: Allan Ghaemi, Princeton, NJ (US); Yanjie Chai, Marlboro, NJ (US)

(21) Appl. No.: 13/185,534

(22) Filed: Jul. 19, 2011

Related U.S. Application Data
(60) Provisional application No. 61/405,692, filed on Oct. 22, 2010.

(51) Int. Cl. G06F 19/00; G01N 25/00

(52) U.S. Cl. 700/97; 374/45

(57) ABSTRACT

A system and method for calibrating optical components is disclosed. The method may include accumulating data indicative of the variation of selected variables with temperature for a batch of sample optical components, over an operating temperature range; determining the values of the selected variables at a single temperature of at least one new optical component for installation within an optical sub-assembly; and estimating the values of the selected variables as a function of temperature over the operating temperature range for the at least one new optical component based on the accumulated data and the values determined at the single temperature.

### CROSS-REFERENCE TO RELATED APPLICATION

This application claims the benefit of U.S. Provisional Patent Application Ser. No. 61/405,692, filed Oct. 22, 2010, [Attorney Docket No. 312-49], entitled “System and Method For Manufacturing Optical Network Terminal Components”, the entire disclosure of which is hereby incorporated by reference herein.

### BACKGROUND OF THE INVENTION

The increasing demand for voice, data and video in the access markets has driven the introduction of the Passive Optical Network (PON) architecture. Referring to FIG. 1 below, at the access end (the right end in the view of FIG. 1) of the PON system is the Optical Network Terminal (ONT) which is located at the customer premises. At the heart of the PON ONT is a Transmit and Receive optical module, an optical Transceiver (Trx), that communicates in the Up-Stream (US) and Down-Stream (DS) directions with the central office equipment.

The ONT is used at the customer premises and is thus regarded as a consumer electronic instrument, and as such it is under mounting pressures for cost reduction. The most expensive component commonly included within the ONT is the Trx (transceiver). Generally, the ONT Trx consists of a Small Form Factor (SFF) Trx that is soldered onto the ONT board.

Accordingly, there is a need in the art for cost improvements in the production of various components of optical network terminals.

### SUMMARY OF THE INVENTION

According to one aspect, the invention is directed to a method that may include accumulating data indicative of the variation of selected variables with temperature for a batch of sample optical components, over an operating temperature range; determining the values of the selected variables at a single temperature of at least one new optical component for installation within an optical sub-assembly; and estimating the values of the selected variables as a function of temperature over the operating temperature range for the at least one new optical component based on the accumulated data and the values determined at the single temperature.

Other aspects, features, advantages, etc. will become apparent to one skilled in the art when the description of the preferred embodiments of the invention herein is taken in conjunction with the accompanying drawings.

### BRIEF DESCRIPTION OF THE DRAWINGS

For the purposes of illustrating the various aspects of the invention, there are shown in the drawings forms that are presently preferred, it being understood, however, that the invention is not limited to the precise arrangements and instrumentalities shown.

FIG. 1 is a block diagram of an optical network;

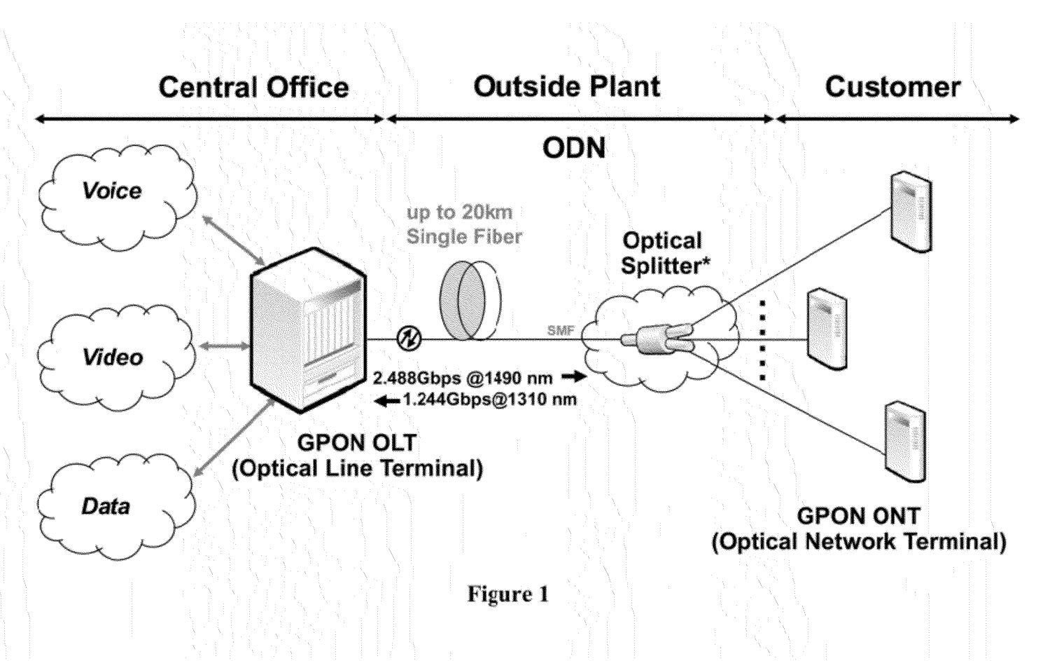

FIG. 2 is a functional block diagram showing the operation of a Bi-directional Optical Sub-Assembly (BOSA) and a peripheral electronics interface;

FIG. 3 is a set of graphs showing the inter-relation of various laser characteristics;

FIG. 4 is a flow diagram of a statistical batch calibration routine for a laser diode in accordance with an embodiment of the present invention;

FIG. 5 is a flow diagram of a room temperature calibration routine in accordance with an embodiment of the present invention;

FIG. 6 is a flow diagram of a method for determining the modulation current of a laser diode as a function of temperature in accordance with an embodiment of the present invention;

FIG. 7 is a graph of characteristics of an avalanche photodiode (APD) in which the maximum Signal to Noise Ratio (SNR) is obtained by biasing the APD for optimum gain, in accordance with an embodiment of the present invention;

FIG. 8 is a flow diagram of a statistical batch calibration routine conducted in accordance with an embodiment of the present invention;

FIG. 9 is a flow diagram of a room temperature calibration routine for an APD in accordance with an embodiment of the present invention;

FIG. 10 is a flow diagram of an APD operation routine initiated from a cold start, in accordance with an embodiment of the present invention; and

FIG. 11 is a block diagram of a computer useable for various functions in connection with one or more embodiments of the present invention.

### DETAILED DESCRIPTION OF THE PREFERRED EMBODIMENTS

In the following description, for purposes of explanation, specific numbers, materials and configurations are set forth in order to provide a thorough understanding of the invention. It will be apparent, however, to one having ordinary skill in the art that the invention may be practiced without these specific details. In some instances, well-known features may be omitted or simplified so as not to obscure the present invention. Furthermore, reference in the specification to phrases such as “one embodiment” or “an embodiment” means that a particular feature, structure or characteristic described in connection with the embodiment is included in at least one embodiment of the invention. The appearances of phrases such as “in one embodiment” or “in an embodiment” in various places in the specification do not necessarily all refer to the same embodiment.

An Optical Network Terminal (ONT) is a modem that is equivalent in function to that of a cable modem situated in a customer premises. The ONT converts data transported in the optical domain over fiber optic cable into an electronic form suitable for use by voice, video, and data equipment such as telephones, televisions and computers respectively. An ONT is thus considered a CPE (consumer premises equipment) device that demands a low selling price typical of that market.

Generally, the most expensive component of an ONT is the optical transceiver—the Trx. The Trx generally needs to be calibrated to deliver a set performance level throughout the operating temperature range, which may be as wide as −40 C (C=Celsius) to +85 C. Typically, this can be a very costly step during manufacturing as it requires calibrating the transceiver at several temperatures within the operating range.

Preferred embodiments of present invention are intended to produce cost savings in the volume manufacturing of ONT modems by doing one or more of the following.

1. Separating the transceiver (also referred to herein as a “trx”) into (a) a constituent Bidirectional Optical Sub-Assembly (BOSA); and (b) Peripheral Electronics (PE), and to place these components directly onto the ONT electronic board.
2. A method is presented to calibrate the resulting structure at a single point (preferably at room temperature) rather than at multiple calibration temperatures. This process simplification leads to lower priced devices and high volume throughput manufacturing when compared to current processes.

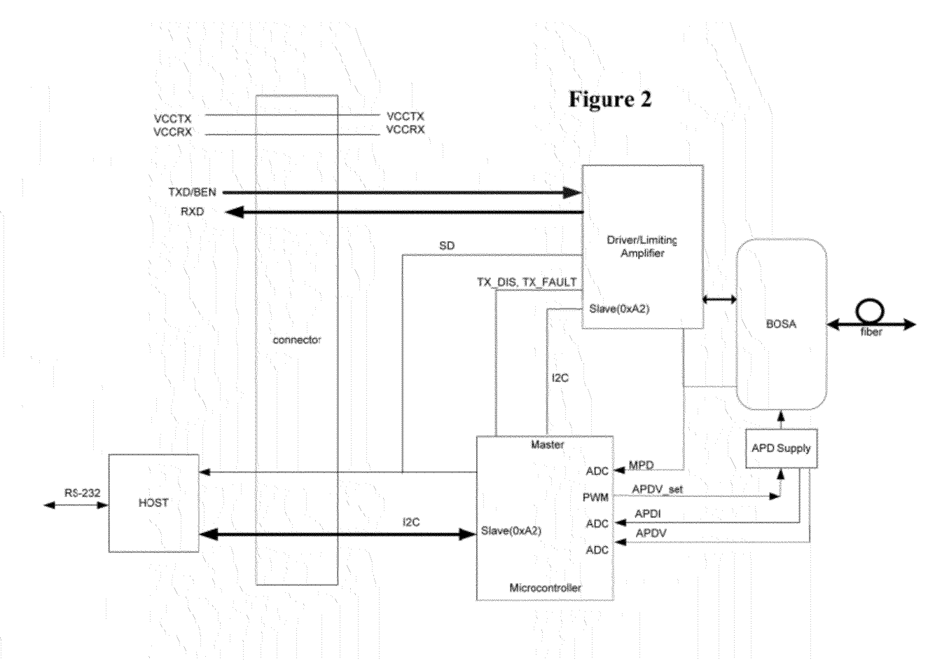

The following is a proposed cost-saving solution that in effect separates the SFF Trx into a Bidirectional Optical Sub-Assembly (BOSA) and the Peripheral Electronics (PE). A functional diagram of one possible implementation is shown in FIG. 2. The BOSA and the PE are preferably mounted directly onto the ONT board. This method is directed to calibrating the BOSA over an entire temperature range, such as between 0 C (Celsius) and +85 C, using characterization data obtained from a statistically significant number of BOSA modules.

For volume manufacturing of ONT modules, it is cost prohibitive to calibrate each and every ONT over the entire operating temperate range. Accordingly, the following is a proposed method for calibrating the BOSA using room temperature data in combination with statistically gathered data pertaining to the thermal characteristics of a given batch of Photodiodes and the Lasers that may be included in the BOSAs. In the following, we present the mathematical equations representing the behavior of ideal Lasers and APDs (Avalanche Photo-Diodes). However, in the general case, the microprocessor enables piece-wise continuous calculations that may be needed to account for non-ideal device behavior.

In a preferred embodiment of the present invention, recalibration of the lasers and/or APDs at different temperatures is unnecessary, since the combination of data from (a) room-temperature calibration of BOSA modules and (b) statistically measured parameters over the module operating temperature range, are sufficient to estimate calibration data over the entire range of operating temperatures.

### Laser Diode Characteristics:

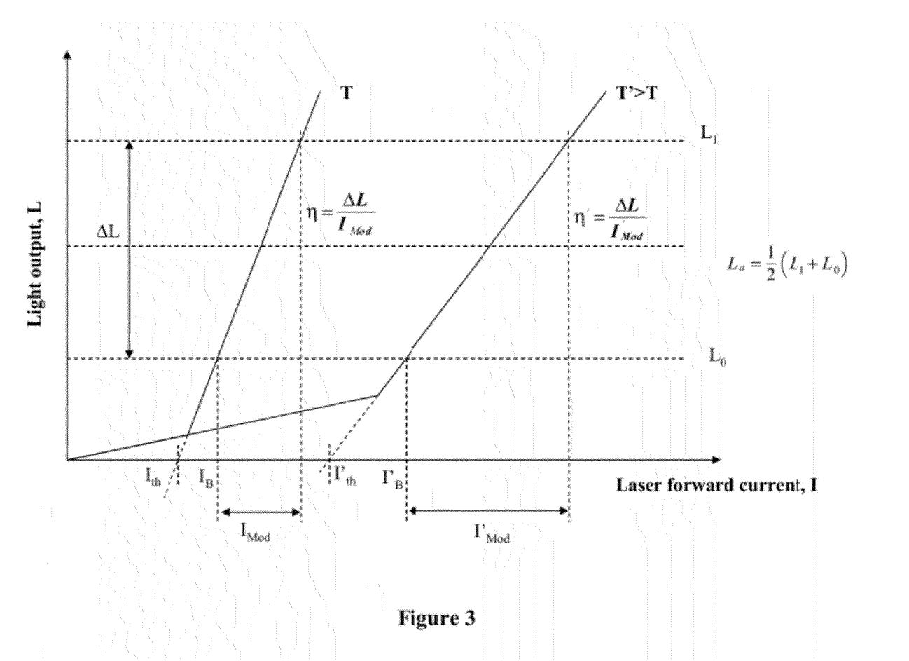

A given Laser diode may be characterized by a light output versus forward bias-current scan as shown in FIG. 3 below. In order to produce a given average output power Lₐ, and a given extinction ratio, r, the laser is driven at the bias current, I_{B}, and modulation current, I_{Mod} The average power, Lₐ, is defined as the average power in the “1” and the “0” states of modulation and is given by:

$${L}_{a} = \frac{1}{2} ( {L}_{1} + {L}_{0} ) \qquad ( 1 )$$

The extinction ratio, r, is defined as the ratio of the power in the “1” state to that in the “0” state and may be written as:

$$r = \frac{{L}_{1}}{{L}_{0}} \qquad ( 2 )$$

The light output, L, at any forward bias current, I, may be written as:

L=η(I−Iₜₕ) (3)

And the slope efficiency, η, may be written as:

$$η = \frac{Δ L}{{I}_{Mod}} \qquad ( 4 )$$

Using equations (3) and (4), the average power may be written as:

$${L}_{a} = η ( {I}_{B} - {I}_{th} + \frac{{I}_{Mod}}{2} ) \qquad ( 5 )$$

Similarly, using equations (3) and (4), the extinction ratio may be written as:

$$r = \frac{{I}_{B} + {I}_{Mod} - {I}_{th}}{{I}_{B} - {I}_{th}} \qquad ( 6 )$$

Rearranging equations (5) and (6) and using the definition for r, we may write for I_{B} and I_{Mod}:

$$\begin{matrix}{I}_{B} = \frac{2 {L}_{a}}{η} \frac{1}{( r + 1 )} + {I}_{th} & ( 7 ) \\ {I}_{Mod} = \frac{2 {L}_{a}}{η} ( \frac{r - 1}{r + 1} ) & ( 8 )\end{matrix}$$

In summary, to have the laser operate at a given average power, Lₐ, and a given extinction ratio, r, a scan of L vs. I is performed and the parameters η and Iₜₕ (threshold current) are determined. Subsequently, the required values of I_{B} and I_{Mod} are calculated using equations (7) and (8) above, respectively.

The threshold current and the slope efficiency defined above are temperature dependent. As the ambient temperature is changed, from T to T′, the laser threshold current Iₜₕ changes approximately according the equation (9):

$${I}_{th}^{′} = {I}_{th} {e}^{\frac{{T}^{′} - T}{{T}_{0}}} \qquad ( 9 )$$

And the slope efficiency changes approximately given by:

$${η}^{′} = η - α ( {T}^{′} - T ) {e}^{\frac{( T - T )}{{T}_{0}}} \qquad ( 10 )$$

In the above, α and T₀ are constants that are preferably established at the time of calibration. According to the discussion above, once the values for the threshold current and slope efficiency are established at a calibration temperature, T, it is then generally possible to predict their values at any another temperature, T′, provided that the calibration constants α and T₀ are established beforehand over the operating temperature range. The same equations (7) and (8) are subsequently used to predict the new required currents, I_{B} and I_{Mod}.

A preferred embodiment of the present invention is directed to a room-temperature calibration of devices (lasers and/or APDs), during volume manufacturing, through the use of a priori measured parameters on a statistically representative sample of Lasers and APDs from the same batch of parts as those being manufactured and calibrated. The parameters measured have been shown to obey Gaussian distributions with an average value and a standard deviation with respect to the average. In order to estimate the errors in establishing the correct average power and extinction ratio we can write equations for the power at the “1” state and the “0” states using equations (3), (7) and (8):

$$\begin{matrix}{L}_{0 d} = 2 {L}_{a} ( \frac{η}{{η}_{d}} ) \frac{1}{r + 1} & ( 11 ) \\ {L}_{1 d} = 2 {L}_{a} ( \frac{η}{{η}_{d}} ) \frac{r}{r + 1} & ( 12 )\end{matrix}$$

The average power and extinction ratio may then be obtained from equations (1) and (2) and may be written as follows:

$$\begin{matrix}{L}_{ad} = {L}_{a} ( \frac{η}{{η}_{d}} ) & ( 13 ) \\ {r}_{d} = r & ( 14 )\end{matrix}$$

From equations (13) and (14) we can derive the uncertainty in setting the average power and extinction ratio:

$$\begin{matrix}δ {L}_{ad} = {L}_{ad} \frac{{δη}_{d}}{{η}_{d}} & ( 15 ) \\ δ {r}_{ad} = 0 & ( 16 )\end{matrix}$$

The implications of equations (15) and (16) are that the uncertainty in setting the extinction ratio is zero and that the fractional uncertainty in setting the average power is equal to that of determining the slope efficiency from the a priori established relations. From a practical standpoint the conclusions that we may arrive from the above analysis are:

1) To ensure that the method presented above remains valid, the threshold current is preferably set above the expected value of the threshold current, at room temperature, which is provided by the manufacturer of the BOSA. The threshold temperature at temperatures other than room temperature may be calculated using equation (9). In one embodiment, to err on the side of safety, the threshold current may be deliberately set above the level that results from the combination of manufacturer specifications and the calculation from equation (9). In one embodiment, the offset (i.e. the amount by which the actual current gets increased over the theoretical current) may be between 0% and 10%. However, in other embodiments, the offset may be greater than 10%.

The magnitude of this overset (also referred to as an “offset”) is arbitrary since optical power is a function of the difference between the applied current and the threshold current. However, for practical purposes, the offset should be kept as small as possible so that the drive currents (bias and modulation) are kept as small as possible over the operating temperature range. If the drive currents are too high, the light output may become non-linear in relation to forward current and in some cases will lead to saturation effects. The threshold current calculated is thus intentionally offset on the high side by a safe margin.

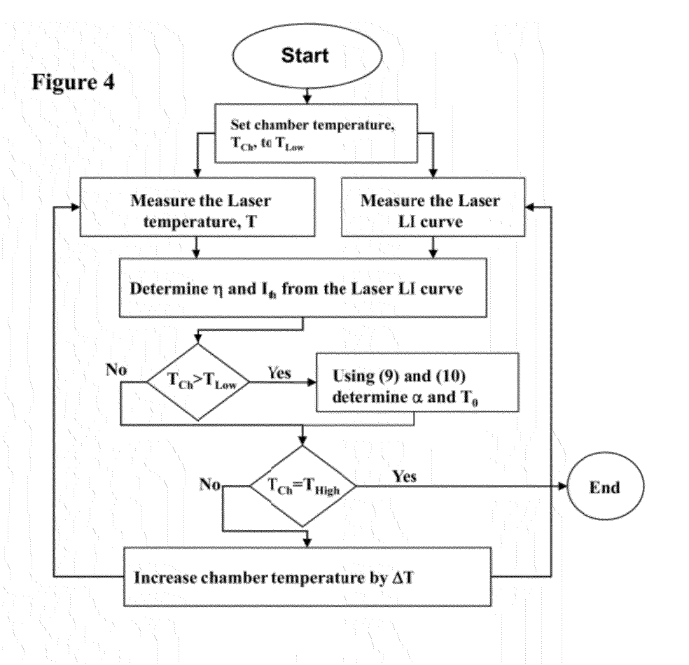

2) The bias current applied to the device should be at a safe margin (also referred to as an offset) above the calculated threshold current. In one embodiment, the “safe margin” may be 0% and 20% of the threshold current. However, in other embodiments, the margin may be more than 20% of the threshold current. Under real world conditions, the magnitude of the margin (of the bias current over the threshold current) may vary among the various batches of parts. In practice, only the bias current is applied and the power derived will depend on the difference between the applied bias current and the real threshold current.
3) The parameters α and T₀ are preferably chosen to lead to average power levels that are greater than the required minimum. This may be ensured by intentionally offsetting the average values in a predetermined direction by a number of standard deviations from the average. In one embodiment, the average values may be offset by one, two, or three standard deviations either upward or downward from the average (i.e. mean) value. In other embodiments, still greater offsets could be employed.
Explanations for the Laser Diode Statistical Batch Calibration Routine for Each Laser Diode from FIG. 4

The Laser diode statistical batch calibration routine is shown in FIG. 4. The basic procedure consists of the following steps.

Each Laser diode from the statistically representative sample is preferably measured at n regular temperature intervals ΔT in an environmental chamber, from temperature T_{Ch} (chamber temperature)=T_{Low} to T_{Ch}=T_{High}. In one embodiment, T_{low} may be 0 C, and T_{high} may be 85 C. However, T_{low} and T_{high} may be either lower or higher than the respective stated values.

Using Equations (9) and (10), the parameters α and T₀ are determined for each laser diode for teach temperature value within the pertinent temperature range. Once data has been collected from the various sample devices, a “look-up table” is constructed consisting of the average values and standard deviations of α and T₀ for the entire batch of sample laser diodes. These values, averages, and standard deviations, are then preferably used during the Laser operating cycle to determine Iₜₕ and η (the slope efficiency) at any temperature using a suitable interpolation algorithm.

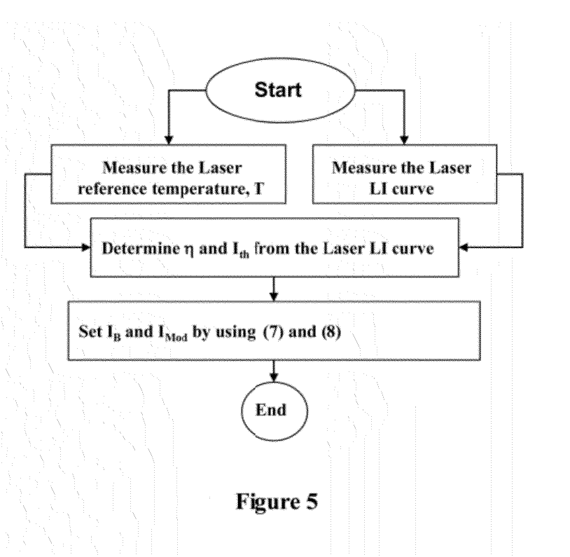

The Laser diode room temperature calibration routine is shown in FIG. 5. The method may include the steps described in the following.

Each Laser diode is scanned to determine the L-I (Power vs. current) curve for that diode. Then, the threshold current, Iₜₕ, and slope efficiency, η, for each laser diode may be determined from the laser L-I curve (i.e. the curve relating current to light power). The bias current, I_{B}, and the modulation current, I_{Mod}, may then be set using equations (7) and (8). In actual practice, it may be possible to use the threshold current, Iₜₕ, and slope efficiency, η, as supplied by the BOSA vendor to calculate the bias current, I_{B}, and the modulation current, I_{Mod} from (7) and (8).

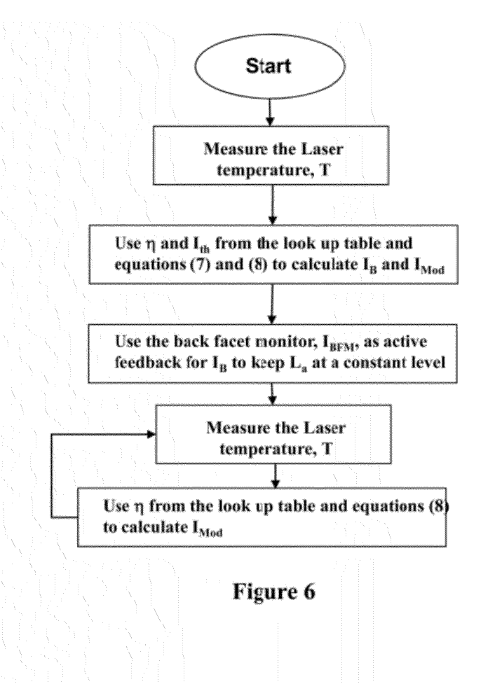

The Laser diode operation routine from a cold start is shown in FIG. 6. The basic procedure may include the steps discussed below. First, we measure the current laser temperature T. Then, using an appropriate interpolation algorithm, we determine η (the slope efficiency) and Iₜₕ from the look-up table, and use equations (7) and (8) to calculate I_{B} and I_{Mod}.

Using the Back Facet Monitor current (IBFM) as feedback, we maintain the average Laser output power, Lₐ. Then, we again measure the laser diode temperature, T. We then use η from the look-up table and equation (8) to calculate I_{Mod} for all subsequent temperatures while the laser remains on.

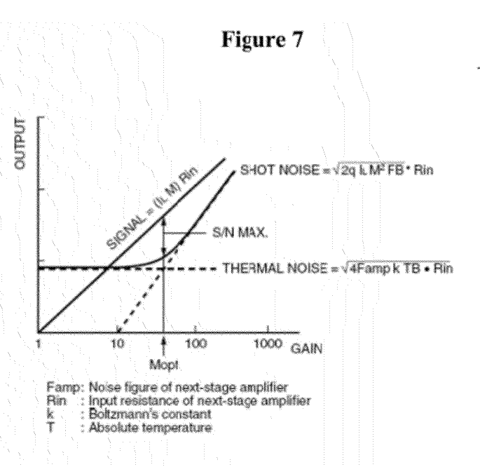

Directing attention to FIG. 7, the Avalanche Photodiode (APD) is the detector of choice for high sensitivity applications. The optimum gain of the APD is determined by varying the reverse bias voltage to produce the maximum Signal to Noise Ratio (SNR) as depicted in FIG. 7.

The APD gain, M, may be expressed by equation (17):

$$M = \frac{A}{{V}_{B} - V} \qquad ( 17 )$$

Where V_{B} is the breakdown voltage, A is a constant, and V is the applied reverse bias voltage. From the above equation, it is clear that the bias voltage should be chosen a safe margin away from the breakdown voltage. The temperature dependence of the APD implies that the optimum gain and hence the optimum bias voltage are also temperature dependent. If the temperature changes from T to T′, the required optimum bias voltage, Vo′ is empirically known to follow the equation:

V₀(T′)=V₀(T)+γ(T′−T) (18)

Where γ is a constant. As in the laser diode calibration discussion above, in a preferred embodiment of the present invention a room temperature calibration of APD devices is conducted using a priori established data from a statistically significant number of devices. In this case, the constant γ is determined from the data. In volume production, the APD is initially at temperature T and is biased at a safe margin below the breakdown voltage which coincides with the optimum voltage. In one embodiment, the APD may be biased at a level three volts below the breakdown voltage. However, in other embodiments, the bias voltage may be more or less than three volts below the breakdown voltage.

The look-up table in the microprocessor contains the values of the optimum voltage as a function of temperature as per equation (18), or a variant of it. The uncertainty in determining γ will in turn cause an uncertainty in determining the bias voltage which in turn will lead to an uncertainty in the receiver sensitivity. This uncertainty in the receiver sensitivity may be estimated as:

$$\frac{δ P}{P} = \frac{δ M}{M} = \frac{δ V}{{V}_{B} - V} = \frac{{T}^{′} - T}{{V}_{B} - V} δγ \qquad ( 19 )$$

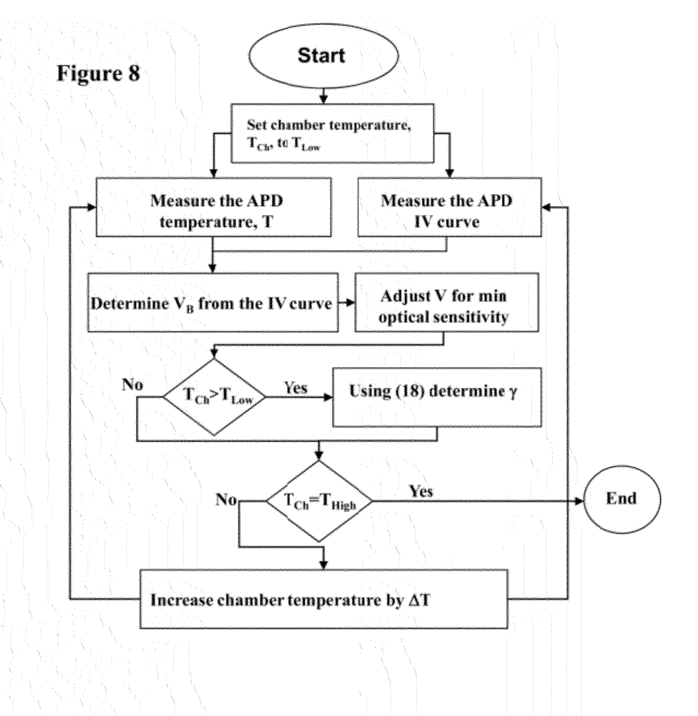

The APD statistical batch calibration routine is shown in FIG. 8. The basic procedure may include the steps discussed below. Each APD from the statistical batch is measured at n temperature values, separated by intervals ΔT (which intervals may all be equal), in an environmental chamber from T_{Ch}=T_{Low} to T_{Ch}=T_{High}. In one embodiment, the low and high temperatures may be 0 C and 90 C, respectively. However, other values of low and high temperatures may be employed.

Using equation (18), the parameter γ is determined for each APD within each ΔT throughout the range.

Once all the data has been collected, a look-up table is constructed that includes the average value and standard deviations of γ for the entire batch of APD devices. These values, averages, and standard deviations can then be used during the Laser operating cycle to determine the optimum bias voltage, V, at any temperature using a suitable interpolation algorithm.

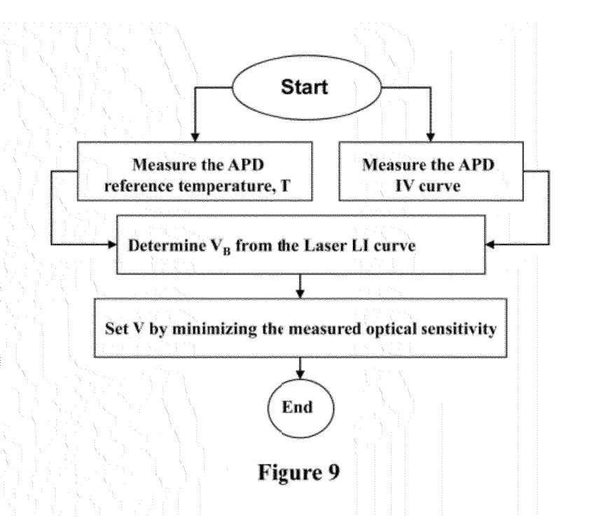

The APD room temperature calibration routine is shown in FIG. 9. The procedure may include the steps discussed in the following. First, we measure the APD temperature T. We then obtain a scan of current vs. light power for each APD; and thereafter determine the breakdown voltage V_{B}. The optimum bias voltage, V, is established by minimizing the optical sensitivity as a function of V. The bias voltage should be a safe margin less than V_{B} at all times. The margin by which the bias voltage is lower than the breakdown voltage may be about three volts. However, voltage margins lower than or greater than three volts may be employed.

In actual practice, it may be possible to use the optimum voltage as supplied by the BOSA vendor to calculate the actual bias voltage using the γ values from the look-up table and equation (18).

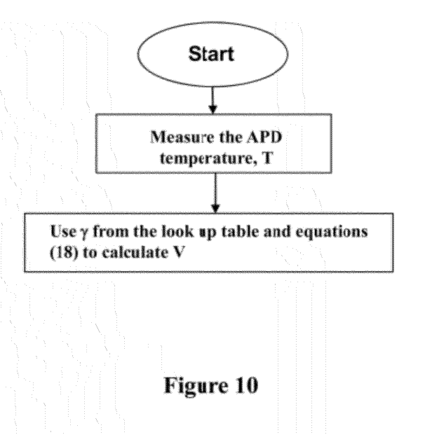

Explanations for the APD Operation Routine from a Cold Start FIG. 10

An embodiment of the APD operation routine from a cold start is shown in FIG. 10. The method may include the steps discussed below. First, we measure the temperature T. Using an appropriate interpolation algorithm, we determine γ from the look-up table and use equation (18) to calculate V.

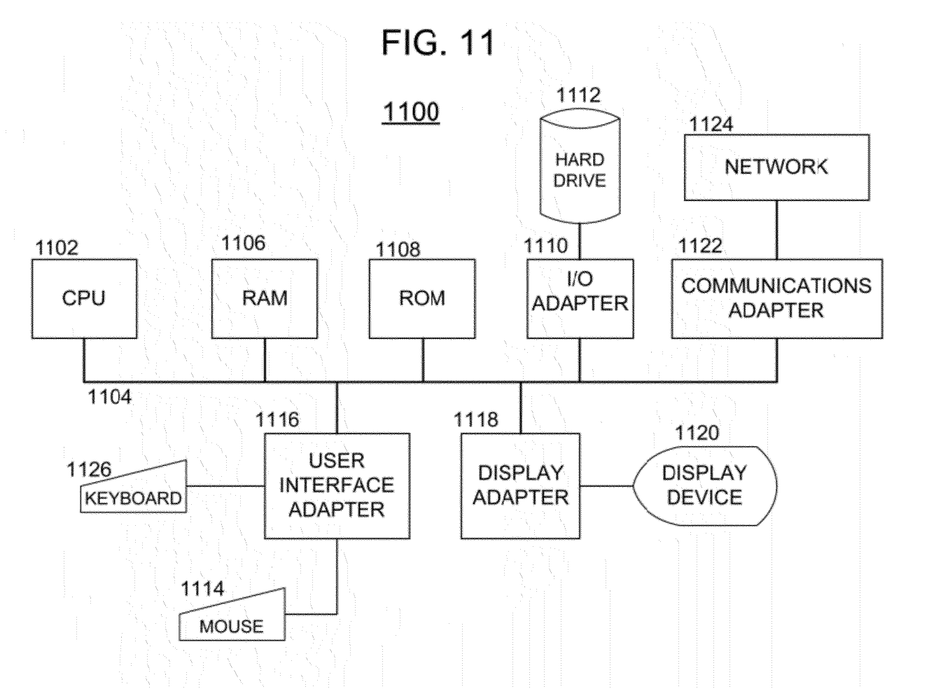

FIG. 11 is a block diagram of a computing system 1100 adaptable for use with one or more embodiments of the present invention. Central processing unit (CPU) 1102 may be coupled to bus 1104. In addition, bus 1104 may be coupled to random access memory (RAM) 1106, read only memory (ROM) 1108, input/output (I/O) adapter 1110, communications adapter 1122, user interface adapter 1106, and display adapter 1118.

In an embodiment, RAM 1106 and/or ROM 1108 may hold user data, system data, and/or programs. I/O adapter 1110 may connect storage devices, such as hard drive 1112, a CD-ROM (not shown), or other mass storage device to computing system 1100. Communications adapter 1122 may couple computing system 1100 to a local, wide-area, or global network 1124. User interface adapter 1116 may couple user input devices, such as keyboard 1126, scanner 1128 and/or pointing device 1114, to computing system 1100. Moreover, display adapter 1118 may be driven by CPU 1102 to control the display on display device 1120. CPU 1102 may be any general purpose CPU.

It is noted that the methods and apparatus described thus far and/or described later in this document may be achieved utilizing any of the known technologies, such as standard digital circuitry, analog circuitry, any of the known processors that are operable to execute software and/or firmware programs, programmable digital devices or systems, programmable array logic devices, or any combination of the above. One or more embodiments of the invention may also be embodied in a software program for storage in a suitable storage medium and execution by a processing unit.

Although the invention herein has been described with reference to particular embodiments, it is to be understood that these embodiments are merely illustrative of the principles and applications of the present invention. It is therefore to be understood that numerous modifications may be made to the illustrative embodiments and that other arrangements may be devised without departing from the spirit and scope of the present invention as defined by the appended claims.

1. A method, comprising:
accumulating data indicative of the variation of selected variables with temperature for a batch of sample optical components, over an operating temperature range;
determining the values of the selected variables at a single temperature of at least one new optical component for installation within an optical sub-assembly; and
estimating the values of the selected variables as a function of temperature over the operating temperature range for the at least one new optical component based on the accumulated data and the values determined at the single temperature.

2. The method of claim 1 further comprising the step of:
calibrating the at least one new optical component in accordance with the values obtained in the estimating step.

3. The method of claim 2 further comprising the step of:
assembling the at least one new optical component onto an optical sub-assembly.

4. The method of claim 1 wherein the selected variables include at least one variable selected from the group consisting of: bias current; modulation current; output power; extinction ratio; slope efficiency; and laser threshold current.

5. The method of claim 1 wherein the selected variables include at least bias current.

6. The method of claim 1 wherein the selected variables include at least modulation current.

7. The method of claim 1 wherein the operating temperature range is between −40 degrees Celsius and 85 degrees Celsius.

8. The method of claim 1 wherein the operating temperature range is between 10 degrees Celsius and 30 degrees Celsius.

9. A method for accumulating calibration data for an optical component, the method comprising:
(a) setting a chamber housing the optical component to an initial temperature;
(b) gathering data describing the variation of output power of the component as a function of bias current to generate power-current curve data (L-I curve data);
(c) increasing the chamber temperature by a non-zero temperature increment to generate a new temperature; and
(d) gathering L-I curve data at the new temperature.

10. The method of claim 9 wherein a succession of non-zero temperature increments are of at least substantially equal magnitude.

11. The method of claim 9 comprising:
repeating steps (c) and (d) for a finite number of temperature increments.

12. The method of claim 9 wherein the finite number of temperature increments extends over an entire operating temperature range of the optical component.

13. The method of claim 11 wherein the operating temperature range is between −40 degrees Celsius and 85 degrees Celsius.

14. The method of claim 12 wherein the operating temperature range is between 10 degrees Celsius and 30 degrees Celsius

15. The method of claim 9 wherein data obtained in the gathering step is stored in digital computer memory.
